(19) United States
(12) Patent Application Publication
(10) Pub. No.: US 2003/0028787 A1
(43) Pub. Date: Feb. 6, 2003

(54) Method and system for discouraging unauthorized copying of a computer program

(75) Inventors: Wassim Fayed, Sammamish, WA (US); Ahmed Azmy Hassan, Bellevue, WA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Microsoft Corporation, Redmond, WA

(21) Appl. No.: 09/923,753

(22) Filed: Aug. 6, 2001

(51) Int. Cl. H04L 9/00

(52) U.S. Cl. 713/189

(57) ABSTRACT

A transponder used in conjunction with a computer software product discourages unauthorized copying. The transponder is attached to or embedded in the computer-readable media (e.g. the CD-ROMs, DVDs) that comes with the product. Before the software product can be installed on a user's computer, the installation software may activate a radio-frequency (RF) device and query the transponder for an identification number. The identification number is associated with the particular copy of the software that the user is attempting to install. The installation software attempts to verify the identification number and, if successful, proceeds with the installation of the software.

### TECHNICAL FIELD

This invention relates generally to discouraging the unauthorized copying of computer software, and, more particularly, to the use of a transponder in conjunction with a computer-readable medium, such as a CD-ROM or DVD, to authenticate a copy of a computer program.

### BACKGROUND OF THE INVENTION

The computer software industry has been plagued by the problem of software piracy for nearly its entire history. In the past few years, software piracy has become an industry in itself. In many foreign countries, for example, entire factories are devoted to churning out CD-ROMs having illegal copies of popular computer programs. While efforts have been made to control this problem, the economic incentive to pirate software has proven to be greater than any fear of law enforcement. Part of the reason for this is that it is much cheaper to copy software than it is to purchase it legally.

Many solutions to this problem have been proposed. One solution involves the use of Radio Frequency Identification (RFID) technology. RF ID technology is more commonly associated with aircraft identification systems, in which each aircraft has a transponder that emits a code in response to receiving radio waves of the correct frequency. The emitted code helps aircraft identify one another and thereby avoid collision or, in the case of military aircraft, avoid firing on each other. This technology has also been used in door entry systems, in which employees of a company are issued security cards, each card having a transponder that transmits an ID code in the presence of an electromagnetic field. To enter a secured door, an employee places his or her security card in close proximity to a card reader. The card reader emits radio waves that cause the security card to respond with an ID code. The security system then determines whether or not to open the door based on the ID code.

The use of RFID technology has also been proposed for protecting software from being pirated. For example, U.S. Pat. Nos. 6,005,940, 6,167,136 and 6,044,046 each describe an anti-piracy system in which computer programs are stored on a CD-ROM in encrypted form. The CD-ROM has an attached transponder that contains a deciphering key, which a computer can use to decrypt the computer programs. Encrypting each copy of a computer program is expensive, however. Furthermore, running an encrypted program is potentially slow and requires excessive computing resources, as the program has to be decrypted during execution.

### SUMMARY OF THE INVENTION

In accordance with the foregoing, the present invention discourages the unauthorized copying of computer software products through the use of transponders that are attached to or embedded in the computer-readable media (e.g. the CD-ROMs, DVDs) with such products. Before the software product can be installed on a user's computer, the installation software may activate a radio-frequency (RF) device and query the transponder for an identification number. The identification number is associated with the particular copy of the software that the user is attempting to install. The installation software attempts to verify the identification number and, if successful, proceeds with the installation of the software.

The RF reader may be implemented in a variety of ways. For example, it may be included in the CD-ROM or DVD drive of a computer or as a stand-alone device. There are also many possible implementations for the transponder. In one implementation, the transponder is attached to the outside of the computer-readable medium with an adhesive material. This makes it easy and convenient for a software manufacturer to add the transponder after the computer-readable medium has been manufactured.

Additional features and advantages of the invention will be made apparent from the following detailed description of illustrative embodiments that proceeds with reference to the accompanying figures.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1 illustrates an example of a computer network;

FIG. 2 illustrates an example of a computer;

FIG. 3 illustrates an example of a computer software product configured according to an embodiment of the invention;

FIG. 4 illustrates an example of hardware that may be used to protect computer software from unauthorized copying in accordance with an embodiment of the invention;

FIG. 4a illustrates an example of where the reader of FIG. 4 can be located in accordance with an embodiment of the invention;

FIGS. 5-6 illustrate an example of a procedure for authenticating and installing computer software according to an embodiment of the invention;

FIG. 7 illustrates a user interface that may be displayed during the procedure described in conjunction with FIGS. 5-6;

FIGS. 8-9 illustrate examples of challenge response procedures that may be used in various embodiments of the invention; and

FIG. 10 illustrates an example of a credit card configured according to an embodiment of the invention.

### DETAILED DESCRIPTION OF THE INVENTION

The invention is generally directed to a method and system for discouraging the unauthorized copying of a computer program. A copy of the computer program is stored on a computer-readable medium, such as a CD-ROM or DVD, that has an attached or embedded transponder. The transponder has an identification number associated with the copy of the computer program that is stored on the computer-readable medium. When a user attempts to install the computer program on a computer, an installation program activates a reader, which retrieves the identification number from the transponder and sends it to the computer. The installation program authenticates the copy of the computer program by verifying the validity of the retrieved identification number. Additionally, the reader and transponder may engage in a cryptological challenge-response procedure to authenticate the copy of the software. The reader may be integrated with, for example, the computer's CD-ROM or DVD drive, or it may be a stand-alone peripheral device that is linked to the computer. Various embodiments of the invention will be described in more detail following a general discussion of possible operating environments in which the invention may be used.

Although it is not required, the invention may be implemented by program modules that are executed by a computer. Generally, program modules include routines, objects, components, data structures and the like that perform particular tasks or implement particular abstract data types. A “program” includes one or more program modules. In some commercial embodiments, multiple programs are bundled together is what will be referred to herein as a “software package.” Examples of software packages include a word processing package, a spreadsheet package, a graphics package, an office productivity software package (having, for example, a word processor, a spreadsheet, and a database program all bundled together in one computer software product), or an operating system package (having, for example, a copy of an operating system along with several utility application programs). The invention may be implemented on a variety of types of computers, including personal computers (PCs), hand-held devices, multi-processor systems, microprocessor-based programmable consumer electronics, network PCs, minicomputers, mainframe computers and the like. The invention may also be employed in distributed computing environments, where tasks are performed by remote processing devices that are linked through a communications network. In a distributed computing environment, modules may be located in both local and remote memory storage devices.

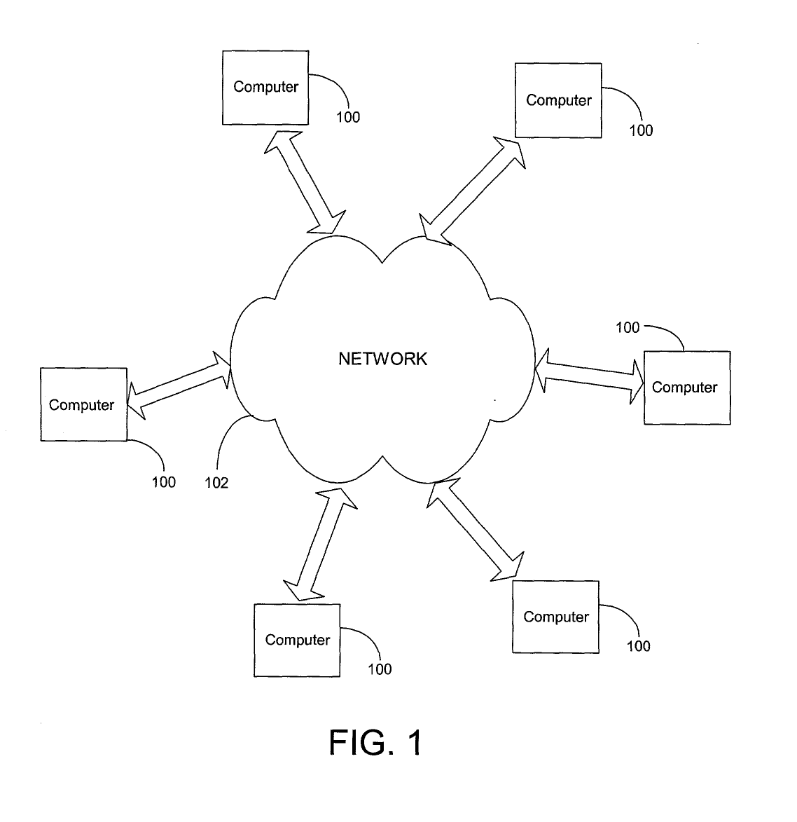

An example of a networked environment in which this system may be used will now be described with reference to FIG. 1. The example network includes several computers 100 communicating with one another over a network 102, represented by a cloud. Network 102 may include many well-known components, such as routers, gateways, hubs, etc. and may allow the computers 100 to communicate via wired and/or wireless media.

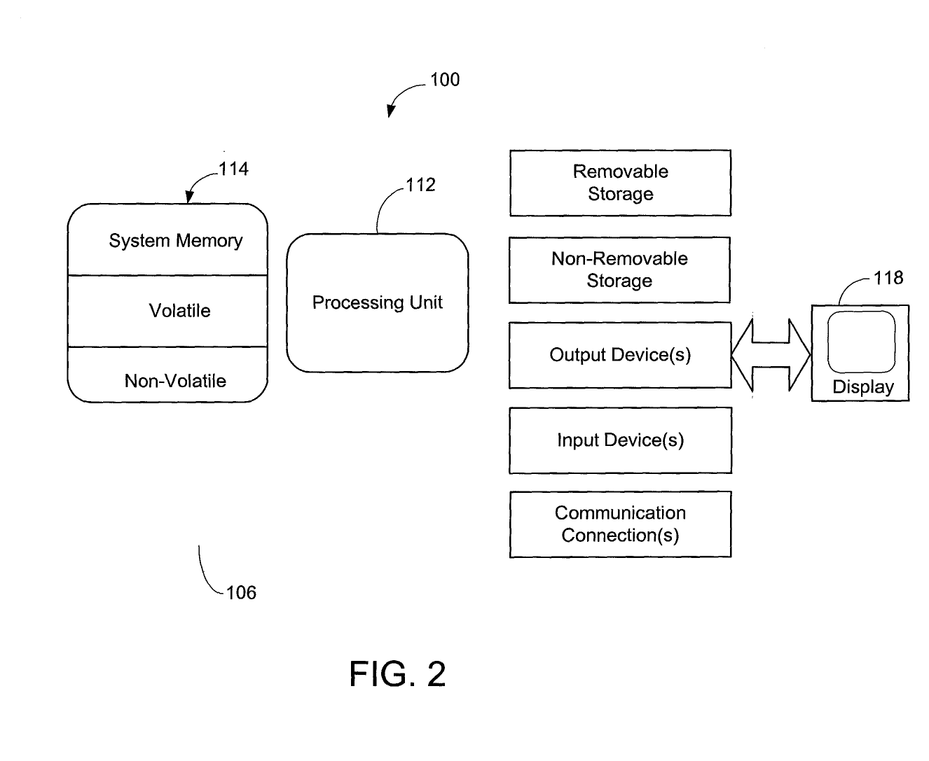

Referring to FIG. 2, an example of a basic configuration for a computer on which the system described herein may be implemented is shown. In its most basic configuration, the computer 100 typically includes at least one processing unit 112 and memory 114. Depending on the exact configuration and type of the computer 100, the memory 114 may be volatile (such as RAM), non-volatile (such as ROM or flash memory) or some combination of the two. This most basic configuration is illustrated in FIG. 2 by dashed line 106. Additionally, the computer may also have additional features/functionality. For example, computer 100 may also include additional storage (removable and/or non-removable) including, but not limited to, magnetic or optical disks or tape. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to stored the desired information and which can be accessed by the computer 100. Any such computer storage media may be part of computer 100.

Computer 100 may also contain communications connections that allow the device to communicate with other devices. A communication connection is an example of a communication medium. Communication media typically embodies computer readable instructions, data structures, program modules or other data in a modulated data signal such as a carrier wave or other transport mechanism and includes any information delivery media. By way of example, and not limitation, communication media includes wired media such as a wired network or direct-wired connection, and wireless media such as acoustic, RF, infrared and other wireless media. The term computer readable media as used herein includes both storage media and communication media.

Computer 100 may also have input devices such as a keyboard, mouse, pen, voice input device, touch input device, etc. Output devices such as a display 116, speakers, a printer, etc. may also be included. All these devices are well known in the art and need not be discussed at length here.

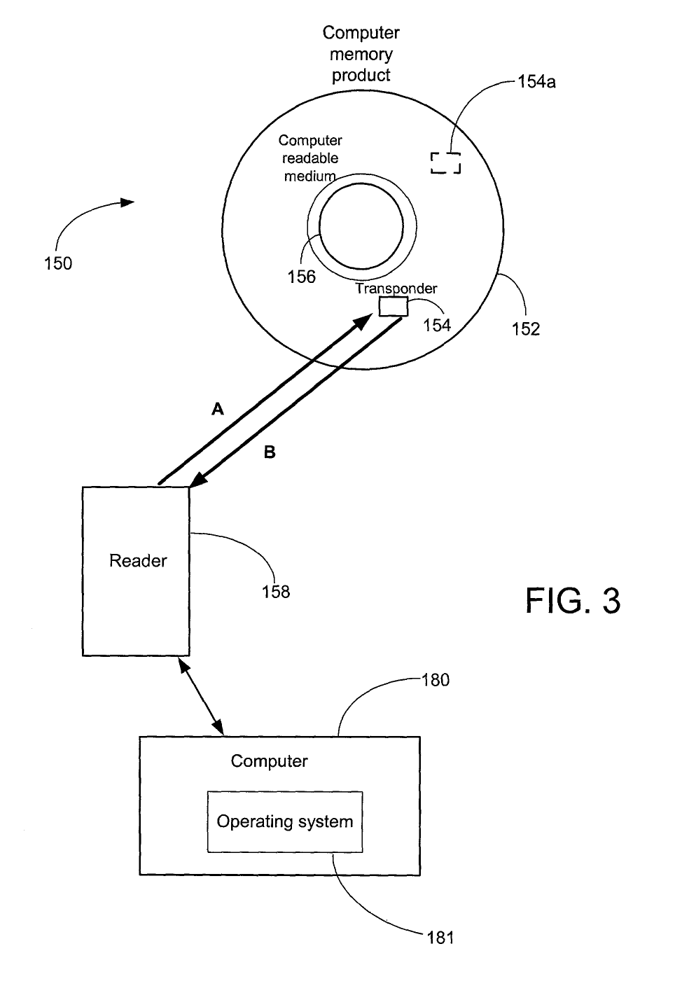

Referring to FIG. 3, a computer software product configured according to an embodiment of the invention is shown. The computer software product is generally labeled 150. Also depicted in FIG. 3 is a reader 158 and a computer 180. An operating system 181 manages many of the functions of the computer 180. The reader 150 is communicatively linked to the computer 180 and can be accessed by application programs running on the computer 180 through one or more interfaces of an operating system of the computer 180. The functions of the reader 158 include transmitting queries in the form of RF signals and detecting RF signal responses. The reader 158 may be implemented as a stand alone peripheral device of the computer 180, or as a component of some other device. For example, the reader 158 can be implemented as a component of a CD-ROM or DVD drive of the computer 180, or integrated into a mouse of the computer 180.

The computer software product 150 includes a computer-readable medium 152, a transponder 154 and an antenna 156 electrically coupled to the transponder 154. The transponder 154 and antenna 156 are disposed so as to maintain physical contact with the computer readable medium 152 and remain fixed relative thereto. For example, if the computer readable medium 152 is a CD-ROM, then the transponder 154 and antenna 156 are fixed so that they rotate with the computer readable medium 152. If the computer-readable medium 152 is a rotatable medium, such as a CD-ROM or DVD, then a counter-balance member 154 may be included to help reduce wobble during those times in which the computer software product rotates. Physical contact between the computer readable medium 152 and the antenna 156 or the transponder 154 can be achieved in a variety of ways. For example, either or both of the transponder 154 and the antenna 156 may be attached to surface of the computer readable medium 152, such as with an adhesive or an adhesive label. Alternatively, they may be embedded inside the computer readable medium 152. An advantage of attaching the transponder 154 and antenna 156 to the surface of the computer-readable medium 152 is that it allows a software manufacturer to add these components to the computer software product 152 after the computer-readable medium 152 has been manufactured.

According to an embodiment of the invention, instructions for carrying out the procedure for authenticating the computer software product 150 are stored on the computer-readable medium 152 as part of an installation program. When a user first purchases the computer software product 150 and attempts to install it on his or her computer, the installation program automatically calls functions of the operating system 181 to activate the reader 158 and start the authentication procedure. The installation program may handle some or all of the authentication details. In some embodiments of the invention, the installation software attempts to detect the reader 158 and, if no reader is detected, disables the automatic authentication procedure, relying instead on the user to enter an identification number, such as the Product ID number that came with the purchased software. Many variations on this basic procedure are possible, and such variations may be implemented according to the desires and needs of the vendor that wrote the software stored on the software product 150. For example, in some embodiments, the installation program does not go through the operating system, but accesses the reader 158 directly. As another example, the installation program need not ask the user to manually enter an identification number but may instead cause the installation procedure to abort, and may display an explanatory message to the user.

Referring again to FIG. 3, the antenna 156 is configured to receive radio signals within a certain range of frequencies. Such radio signals induce a flow of electrical current in the antenna 156. This current travels to the transponder 154. The transponder 154 uses the energy transferred via the current to perform one or more logical operations. The transponder 154 also uses the energy from the current to form induced RF signals and to broadcast the induced RF signals via the antenna 156.

Referring again to FIG. 3, an example of the communication flow between the reader 158 and the transponder 154 will now be described. The reader 158 broadcasts that a query in the form of an RF signal (arrow A). The RF signal induces a current in the antenna 156, thereby energizing the transponder 154. The transponder 154 broadcasts a response, such as an ID number or cryptological challenge (Arrow B). The response is used by the reader 158 and/or the computer 180 to determine whether the computer-memory product 150 is authentic. In making this determination, the reader 158 may broadcast further signals so as to elicit further responses from the transponder 154.

In some embodiments of the invention, the transponder 154 responds to the reader 158 by transmitting a Product ID number (PID) that is unique to each individual computer software product (CD-ROM, DVD, etc.). For example, the computer-readable medium 152 might be a CD-ROM that has a word processing program stored on it. Each copy of the word processing program (i.e., each individual CD-ROM sold with the word processing program) may have its own unique PID. There may be a group of PID's associated with each version of the program as well. For example, the trial version of the word processing program might be associated with one set of PID's, while the fully functional version might be associated with another set of PID's. Each software manufacturer may have its own system for creating and keeping track of PIDs.

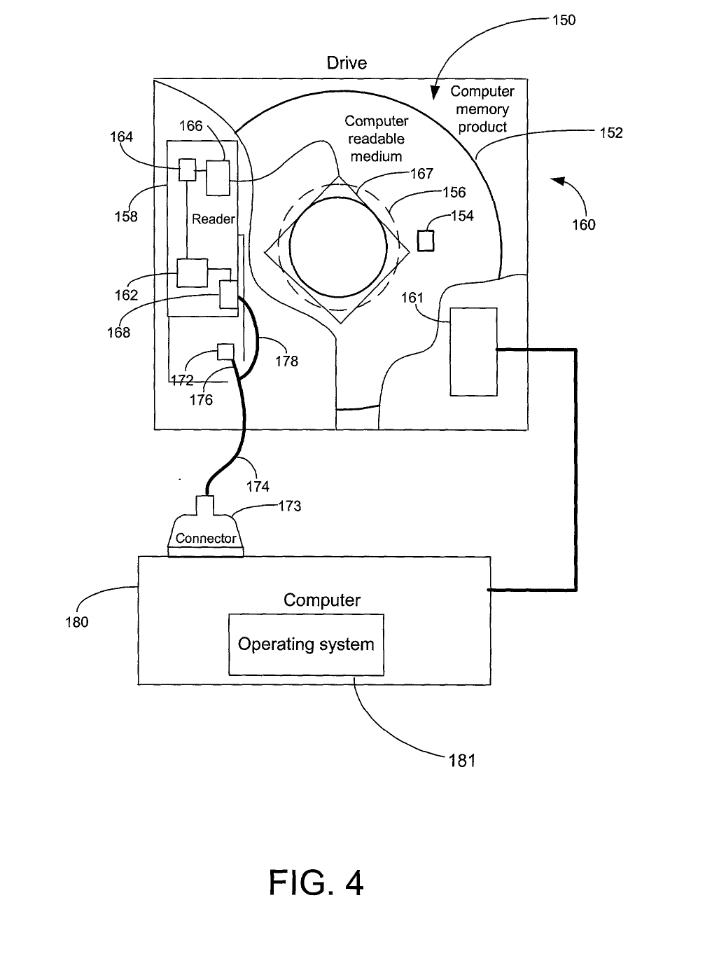

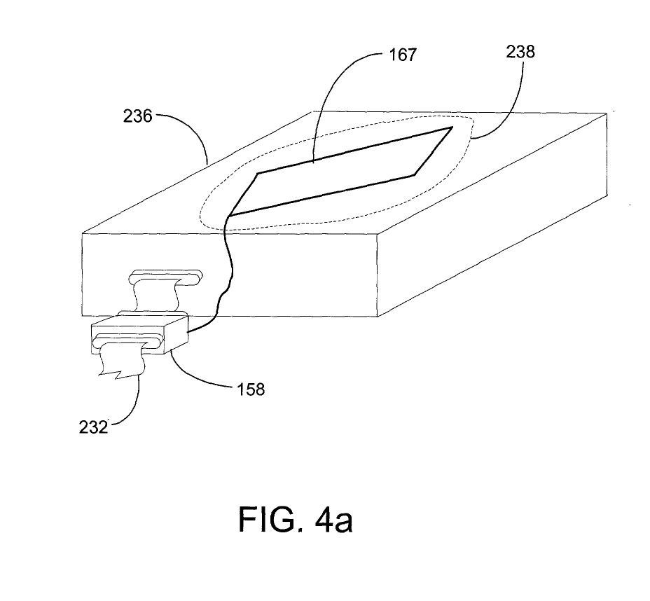

An example of hardware that may be used to protect computer software from illegal copying in accordance with an embodiment of the invention will now be described. Referring to FIG. 4, the computer software product 150 of FIG. 3 is shown inside a drive, generally labeled 160. The drive 160 includes an electro-optical module 161 for reading data from and writing data to the computer-readable medium 152. In this embodiment, the computer-readable medium 152 is assumed to be either a compact disk (CD) or digital versatile disk (DVD). The Product ID (PID) of the software product 150 is assumed to be stored in the transponder 154. The drive 160 further includes the reader 158 from FIG. 3. In this embodiment, the reader 158 includes a controller 162 for performing the logic functions of the reader 158 and directing the activities of the other components of the reader 158. The reader 158 also includes a digital-to-analog/analog-to-digital (AD/DA) converter 164 electrically coupled to the controller 162 and an RF receiver/transmitter 166 electrically coupled to AD/DA converter 164. The AD/DA converter 164 converts digital signals received from the controller 162 into analog signals, which are then transmitted to the RF transmitter/receiver 166. Conversely, the AD/DA converter 164 converts analog signals received from the RF transmitter/receiver 166 into digital signals, which are then transmitted to the controller 162. The RF transmitter/receiver 166 transmits and receives RF signals via an antenna 168. The reader 158 also includes an interface 168 electrically coupled to the controller 162. The interface 168 facilitates communication between the reader 158 and other components. The drive 160 also includes a switch 172 electrically coupled to the controller 162 for regulating the flow of power to the reader 158.

The components of the reader 158 may be implemented in a variety of ways. For example, the controller 162 may be implemented as an ATMEL 89DS8515 controller, the RF transmitter/receiver 166 may be implemented as an ATMEL 24RF08 transmitter/receiver, and the interface 168 may be implemented as an RS-232 interface. There are also a variety of possible implementations for the transponder 154, including a MICROCHIP brand, model MCRF250 or MCRF450 transponder.

In the illustrated embodiment (FIG. 4), the drive 160 is electrically coupled to a computer 180 by a connector 173. The connector 173 includes a cable 174 having a power section 176 coupled to the switch 172 and a data section 178 coupled to the interface 168. The power section 176 includes one or more lines for delivering current and at least one data line for delivering an “on” or “off” signal to the switch 172. The data section 178 includes one or more lines for sending and receiving authentication data to and from the controller 162 via the interface 168. There are a variety of possible implementations for the connector 172, including a serial connector.

As previously discussed, the reader 158 (FIGS. 3 & 4) can be coupled to a computer in a variety of ways. For example, the reader may be in series with an Integrated Drive Electronics (IDE) cable running from the computer's motherboard to the CD-ROM or DVD drive, as shown in FIG. 4a. The IDE cable, labeled 232, is coupled to the reader 158. The reader 158 passes the signals that travel over the IDE cable to a CD-ROM drive 236 and vice versa. The antenna 167 of the reader 158 is attached to an outside surface of the drive 236 with a piece 238 of adhesive material. In this embodiment, a legacy CD-ROM or DVD drive can be easily retrofitted with a reader.

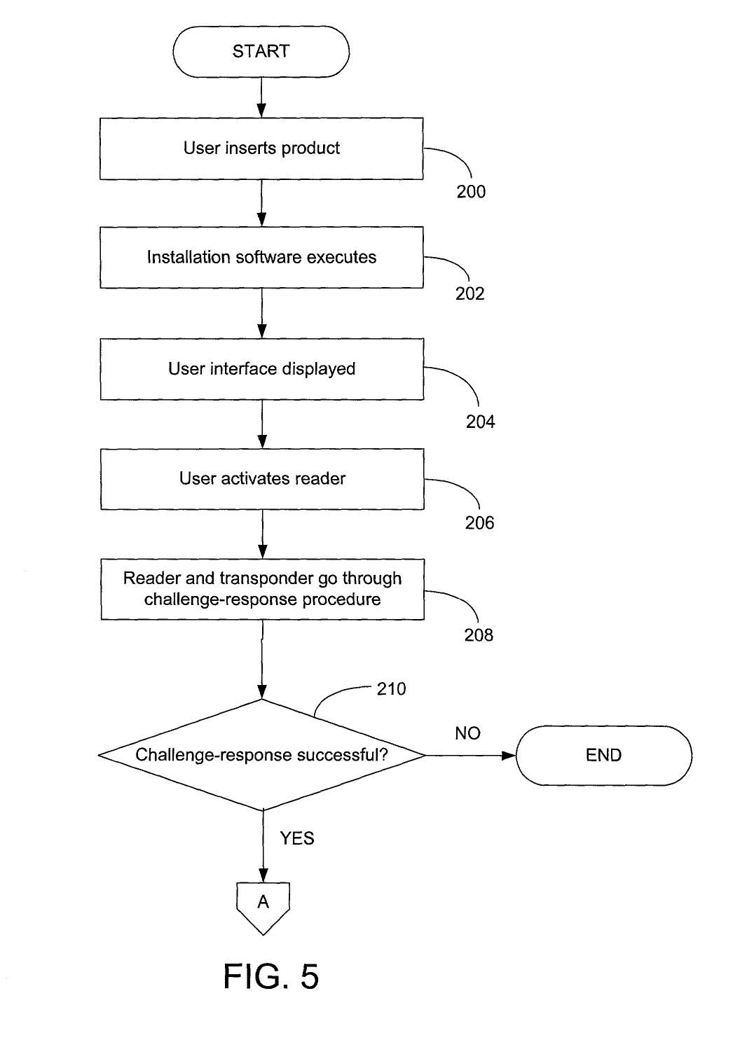

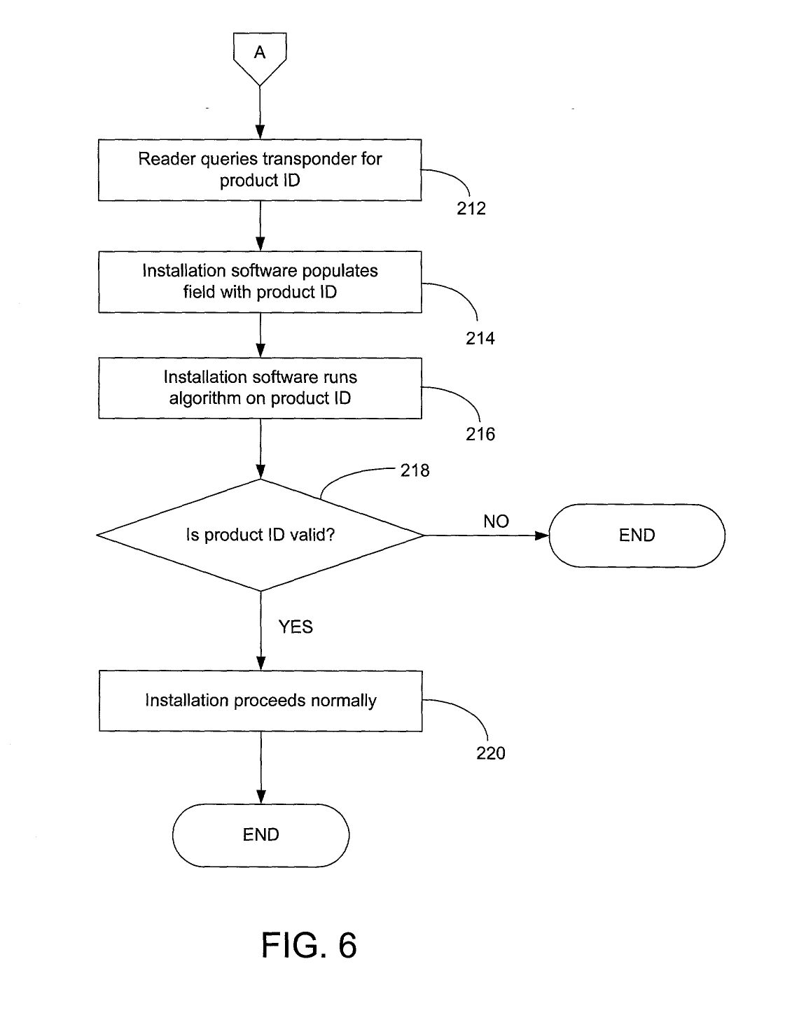

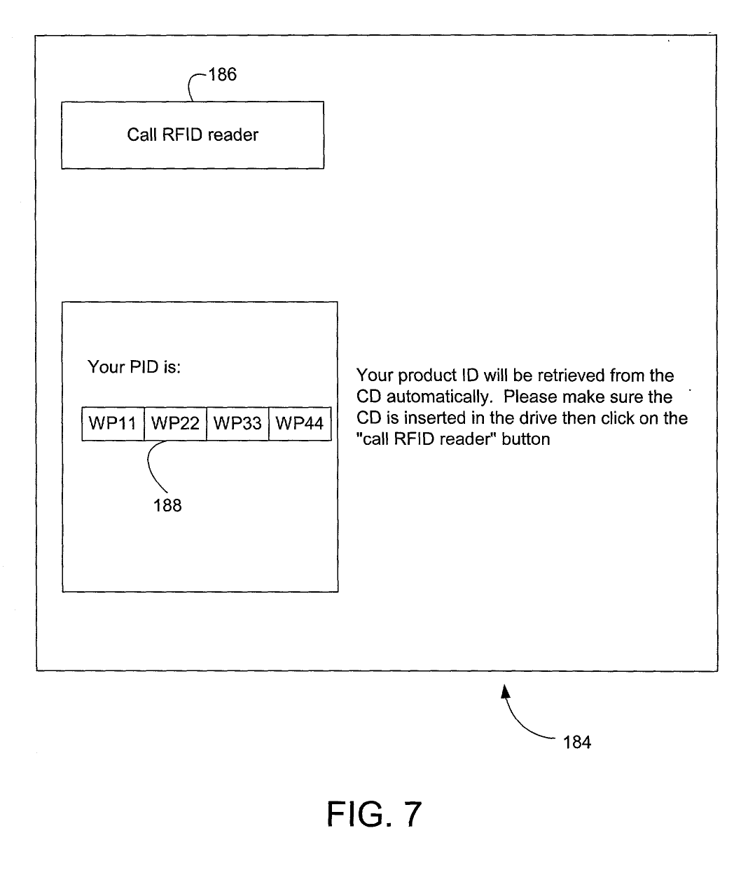

Referring to the flowchart of FIGS. 5 and 6, and with appropriate reference to FIG. 4 and FIG. 7, an example of a procedure for authenticating and installing computer software according to an embodiment of the invention will now be described. The procedure begins at step 200, at which user inserts the computer-memory product 150 into the drive 160. At step 202, the computer 180 executes the installation program stored on the computer-readable medium 152. At step 204, in accordance with the installation program, the computer 180 displays a user-interface 184, shown in FIG. 7. The user interface 184 prompts the user to make sure the computer software product 150 is in the drive 160 and to click on a button 186. At step 206, the user clicks on the button 186 to activate the reader 158 (FIG. 4). In response to the user's action, the computer 180 activates the reader 158 by, for example, sending an “on” signal to the switch 172 via the power section 176 of the cable 174. The switch 173 responds by allowing current to pass from the computer 180 to the reader 158. At step 208, the reader 158 initiates a challenge-response sequence with the transponder 154. There are a variety of ways in which step 208 may be performed, as will be discussed below.

At step 210, if the challenge-response sequence of step 208 is not successful, then the entire installation procedure ends. If the challenge-response sequence is successful, then control passes to step 212 (FIG. 6), at which the reader 158 (FIG. 4) queries the transponder 154 for the PID. When the reader 158 receives the PID, it sends it to the computer 180. At step 214, the computer 180, operating according to the installation program, populates a PID field 188 (FIG. 7) of the user interface 184 with the PID received from the transponder 154. At step 216, the computer 180, again operating according to the installation program, runs an algorithm on the PID to ensure it is valid. At step 218, if the PID is determined to be valid, then the flow proceeds to step 220, at which the installation procedure continues in a conventional manner. If the PID is determined to be invalid at step 218, then the process ends.

There are many possible variations on the procedure shown in FIGS. 5 & 6. Such variations may be implemented at the discretion of the manufacturer of the computer software product. For example, instead of requiring the user to click on an on-screen button to activate the reader, the installation software may automatically activate the reader without any prompting from the user.

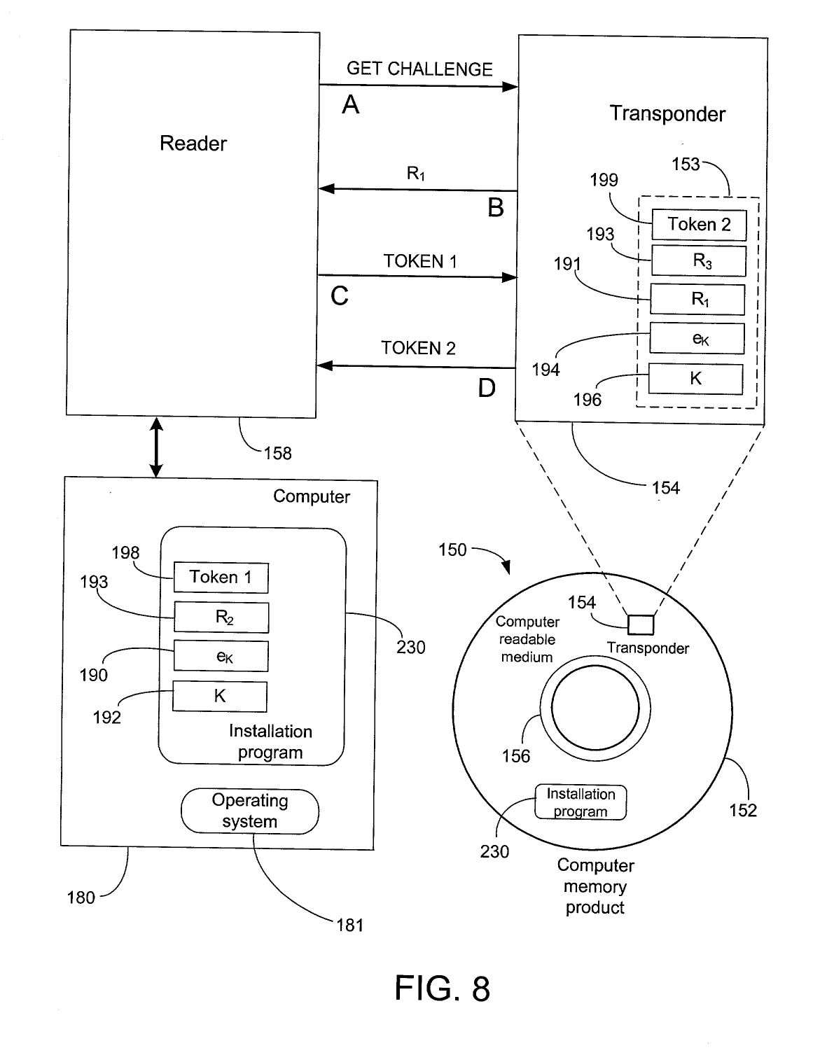

An example of how the challenge-response procedure of step 208, FIG. 5 is implemented according to an embodiment of the invention will now be described with reference to FIG. 8. In this example, the installation program, generally labeled 230, and the transponder 154 both share a secret algorithm and a secret key. The installation program includes a data structure 190 for storing the secret algorithm, referred to as e_{K} and a data structure 192 for storing the secret key, referred to as K. Similarly, the transponder 154 includes a memory 153 having stored therein a data structure 194 for storing e_{K} and a data structure 196 for storing K. The procedure begins during the installation process, when the installation program 230, having already been loaded into the computer 180, orders the reader 158 to transmit a “GET CHALLENGE” signal to the transponder 154 (Arrow A), indicating that it is prepared to receive a cryptological challenge. The transponder 154 responds by generating a first random number R₁ and storing it in a data structure 191. It then transmits the first random number R₁ to the reader 158 (Arrow B).

The installation program 230 then generates a second random number R₂ and stores it in a data structure 193. Using the algorithm eₖ, the installation program 230 creates a first data block, referred to herein as Token 1, as a function of the first random number R₁, the second random number R₂ and the secret key K:

Token 1eₖ(R₁∥R₂∥K)

The installation program 230 stores Token 1 in a data structure 198, and then sends Token 1 to the reader 158 for transmission to the transponder 154 (Arrow C). The transponder 154 receives Token 1 and uses the algorithm eₖ to extract the values of both R₁ and R₂. The transponder 154 then compares the value of R₁ extracted from Token 1 with the value of R₁ stored in the data structure 191. If they are not equal, then the challenge response procedure fails. If they are equal, then the transponder 154 generates a third random number R₃ and stores it in a data structure 193. The transponder 154 uses the algorithm eₖ to create a second data block, referred to herein as Token 2, as a function of the second random number R₂, the third random number R₃ and the secret key K:

Token 2=eₖ(R₂∥R₃∥K)

generates a second data block, referred to herein as Token 2, using the common key algorithm eₖ, and stores it in a data structure 199.

The transponder 154 then transmits Token 2 to the reader 158 (Arrow D). The reader 158 passes Token 2 to the installation program 230. The installation program 230 uses the algorithm eₖ to extract the value of R₂, and then compares the value of R₂ extracted from Token 2 with the value of R₂ stored in the data structure 193. If they are not the same, then the challenge-response procedure ends in failure. If they are the same, then the challenge-response procedure ends in success.

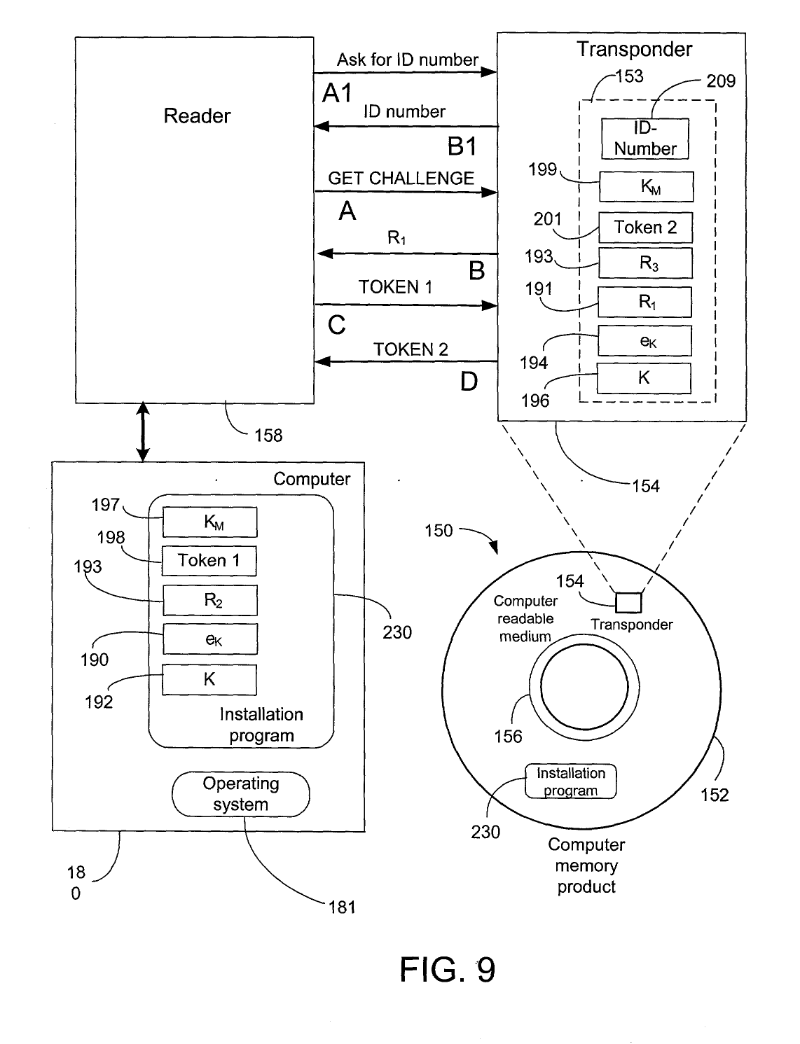

Referring to FIG. 9, another example of how the challenge-response procedure of step 206, FIG. 5 may be implemented will now be described. In this example, the reader 158 and the transponder 154 each possess, in addition to the data structures shown in FIG. 8, a master key number Kₘ stored in respective data structures 197 and 201, as well as a cryptological algorithm c_{K}, stored in respective data structures 203 and 205. The transponder 154 also has an ID number stored in a data structure 209. The ID number may be associated with a variety of possible values, including the transponder serial number or the PID of the software being installed.

The process begins when the installation program 230 orders the reader 158 to query the transponder for an ID number (Arrow A1). In response, the transponder 154 transmits the ID number to the reader 158 (Arrow B1). The rest of the procedure, symbolized by arrows A, B, C and D, is identical to the procedure described in FIG. 8, except that the secret key K that is used in the function eₖ is derived using the crypto logical algorithm c_{K} with the ID number and the master key Kₘ as inputs:

K=cₖ(ID number∥Kₘ).

There are a variety of purposes to which the present invention may be applied. Referring to FIG. 3, the computer software product 150 may be a computer game product, for example, in which information relating to a game, such as a player's score or level, is stored in the memory of the transponder 154. This allows the owner of the computer game product to, for example, take the computer software product 150 to a friend's house and have all of the information transferred. The transponder 154 may also be used to store configuration settings for a game or for any other kind of program, including word processing programs, spreadsheet programs, and the like. This allows a user to reinstall the program without having to reenter the configuration settings.

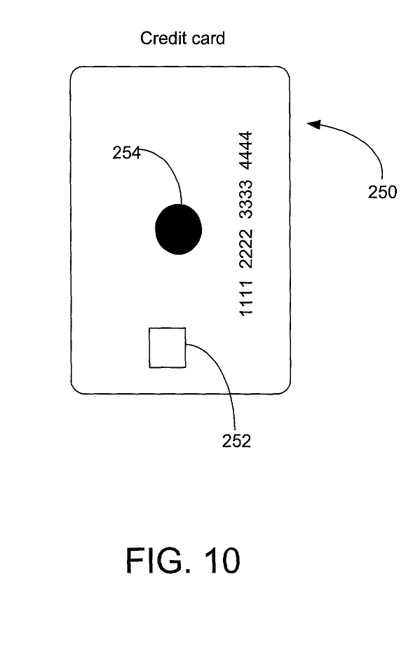

According to another embodiment of the invention, the transponder 154 (FIGS. 3, 4, 8 and 9) can also store username and password information for use in conjunction with a software package stored on the computer-readable medium 152 of the computer software product 150. As shown in FIG. 7, this info could be obtained from the user during the installation procedure. In another embodiment, the teachings of the present invention are used to facilitate on-line credit card purchases. Referring to FIG. 10, a credit card usable in accordance with the invention is shown. The credit card, generally labeled 250, includes a transponder 252 and has a hole 254 in its center to allow it to be inserted into the drive 160 of FIG. 4. The reader 158 can authenticate the credit card 250 in the manner described in conjunction with FIGS. 3, 5, 6, 8 and 9. For example, instead of entering a PID, the user could enter the credit card number. This embodiment of the invention may help reduce the incidence of credit card fraud.

It can thus be seen that a new and useful method and system for discouraging unauthorized copying of a computer program has been provided. In view of the many possible embodiments to which the principles of this invention may be applied, it should be recognized that the embodiments described herein with respect to the drawing figures is meant to be illustrative only and should not be taken as limiting the scope of invention. For example, those of skill in the art will recognize that the elements of the illustrated embodiments shown in software may be implemented in hardware and vice versa or that the illustrated embodiments can be modified in arrangement and detail without departing from the spirit of the invention. Therefore, the invention as described herein contemplates all such embodiments as may come within the scope of the following claims and equivalents thereof.

We claim:

1. A method for determining the authenticity of a computer software product, the computer software product comprising a computer-readable medium and a transponder, the computer-readable medium having stored thereon a copy of a computer program, the method comprising:
generating an electromagnetic field to energize the transponder;
receiving from the transponder a value of an identification number of a copy of the computer program;
analyzing the identification number value to determine whether the identification number value is valid; and
allowing or denying the installation of the copy of the computer program based on the analyzing step.

2. A computer-readable medium having stored thereon computer-executable instructions for performing the method of claim 1.

3. The method of claim 1, further comprising:
receiving a cryptologically-derived block of data transmitted by the transponder; and
analyzing the block of data using a secret algorithm that is commonly shared with the transponder to authenticate the computer software product.

4. The method of claim 3, further comprising receiving a randomly generated number from the transponder, wherein the analyzing step comprises:
extracting a numerical value from the received block of data; and
comparing the numerical value with the received randomly generated number.

5. The method of claim 1, wherein the analyzing step comprises:
determining which version of the program is stored on the computer-readable medium; and
determining whether the identification number is proper for the program version.

6. The method of claim 1, wherein the one or more unencrypted programs are part of a software package, and wherein the analyzing step comprises:
determining which version of the software package is stored on the computer-readable medium; and
determining whether the identification number is proper for the software version.

7. A method for installing a software package on a computer, the method comprising:
executing an installation program of the software package, the installation program being stored on a computer software product comprising a transponder;
in accordance with the installation program, sending a radio frequency signal to a reader that is linked to the computer, thereby causing the radio frequency reader to query the transponder for a product identification number of the computer software product, wherein the product identification number identifies the particular copy of the software package being installed;
analyzing the product identification number to determine whether it is valid; and
based on the analyzing step, determining whether or not to install the software on the computer.

8. A computer-readable medium having stored thereon computer-executable instructions for performing the method of claim 7.

9. The method of claim 7, wherein the activating step comprises calling a function of an operating system of the computer to cause an activation signal to be sent to the reader.

10. The method of claim 7, further comprising:
displaying to a user a field for entering the product identification number;
performing the activating step in response to a user indicating a desire to have the product identification number automatically retrieved;
receiving the product identification number from the transponder; and
populating the field with the received product identification number.

11. The method of claim 10, further comprising:
soliciting the user for a username and password to use in conjunction with the software package; and
storing the username and password in a memory of the transponder.

12. The method of claim 7, further comprising:
if, according to the analyzing step, the product identification number is determined to be valid, retrieving user-defined configuration information from the transponder;
installing the software package on the computer; and
configuring the software in accordance with the user-defined configuration information retrieved from the transponder.

13. A computer software product comprising:
a computer-readable medium having stored thereon programs comprising an application program and an installation program; and
a transponder attached to the computer readable medium, wherein the transponder transmits an authentication signal to a reader that is communicatively linked to a computer, the authentication signal representing data comprising the product identification number, thereby allowing the computer to make a determination of the authenticity of the computer software product and to install the application program based on the authenticity determination.

14. The computer software product of claim 13, wherein the transponder has a memory having stored thereon a secret algorithm shared with an installation program that controls the reader.

15. The computer software product of claim 13, wherein the transponder has a memory having stored thereon a secret key shared with the installation program.

16. The computer software product of claim 13, wherein the computer-readable medium has stored thereon a game program, and the transponder has a memory having stored thereon data comprising status information regarding an in-progress game.

17. The computer software product of claim 13, wherein the computer-readable medium is an disk, the computer software product further comprising a counterbalance member disposed on the computer-readable medium so as to reduce the wobble of the computer-readable medium as it spins.

18. The computer software product of claim 13, wherein the transponder is attached to a surface of the computer readable medium.

19. The computer software product of claim 13, wherein the transponder is embedded within the computer-readable medium.

20. A system for discouraging unauthorized copying of a computer program, the system comprising:
a computer;
a computer software product comprising:
a computer-readable medium having stored thereon one or more programs including an installation program; and
a transponder having stored thereon a number for identifying the computer software product;
and a reader in communication with the computer,
wherein when the computer executes the installation program, the computer signals the reader to query the transponder for the number and analyzes the number to determine the authenticity of the computer software product.

21. The system of claim 20, wherein the computer-readable medium is an optical disk, the system further comprising:
an optical disk drive, wherein the reader is located next to the optical disk drive.

22. The system of claim 20, further comprising:
a handheld input device, wherein the reader is integrated with the handheld input device.

23. The system of claim 20, further comprising an optical disk drive, wherein the reader is in series with a cable leading to the optical disk drive, and wherein data traveling between the computer and the optical disk drive via the cable are passed through the reader.

24. The system of claim 20, further comprising:
an optical disk drive for reading the one or more programs from the computer-readable medium;
an antenna electrically coupled to the reader; and
a piece of adhesive material incorporating the antenna, the piece of adhesive material being attached to the optical disk drive.

25. An apparatus for use in preventing the unauthorized duplication of a computer program, the apparatus comprising:
a transponder having stored therein an identification number associated with a particular copy of the computer program.

26. The apparatus of claim 25, further comprising a means for attaching the transponder to a computer-readable medium having stored thereon the copy of the computer program with which the identification number is associated.

27. The apparatus of claim 26, wherein the attaching means is a layer of adhesive disposed on a surface of the transponder.

28. The apparatus of claim 26, wherein the attaching means is a piece of adhesive label disposed on a surface of the transponder.

29. A credit card having a hole that is sized to fit on a spindle of an optical disk reader of a computer, the credit card comprising:
a transponder having stored thereon data for allowing an RF reader communicatively linked to the computer to verify the authenticity of the credit card.
